(19) United States
(12) Patent Application Publication
(10) Pub. No.: US 2006/0053846 A1
(43) Pub. Date: Mar. 16, 2006

(54) Control mechanism for lock assembly

(76) Inventors: Lan-Shi Huang, Kaohsiung (TW); Chun-Cheng Lin, Kaohsiung Hsien (TW)

Correspondence Address: BIRCH STEWART KOLASCH & BIRCH, PO BOX 747, FALLS CHURCH, VA, 22040-0747, US

(21) Appl. No.: 10/937,299

(22) Filed: Sep. 10, 2004

(51) Int. Cl. E05B 59/00; E05B 63/14

(52) U.S. Cl. 70/107

(57) ABSTRACT

A lock assembly includes a fixing plate fixed to an inner side of a door. An inside rose liner is fixed to the fixing plate. A shaft is rotatably mounted in an axial hole of the fixing plate and coupled with a tail piece of an auxiliary lock body. An inside handle includes an inside spindle rotatably mounted in another axial hole of the fixing plate. A control mechanism includes a sliding plate slidably mounted in the inside rose liner, a driving wheel mounted on the inside spindle to turn therewith, and a driven wheel mounted on the shaft to turn therewith. Each of the driving wheel and the driven wheel includes at least one pressing section on an outer periphery thereof for pressing against an associated pressing portion of the sliding plate. The auxiliary lock is simultaneously unlatched when the inside handle is turned.

### BACKGROUND OF THE INVENTION

1. Field of the Invention

The present invention relates to a control mechanism for a tubular lock. In particular, the present invention relates to a control mechanism for a lock assembly comprising a tubular lock and an auxiliary lock, wherein the auxiliary lock is unlatched when an inside handle of the tubular lock is turned.

2. Description of Related Art

U.S. Pat. No. 5,325,687 discloses a control mechanism for a door lock. As illustrated in FIG. 5 of the drawings which corresponds to FIG. 1 of U.S. Pat. No. 5,325,687, the control mechanism for a door lock comprises an outer cap 91 fixed on the outer portion of the door, an inner cap 92 fixed on the inner portion of the door, a lock mechanism 911 and an outside knob 912 secured in the outer cap 91, a knob 921 and an inside knob 922 provided on the inner cap 92, and two latches 913 and 914 controlled by the lock mechanism 911, the knob 921, and the inside and outside knobs 912 and 922.

A plate 93 is coupled to an axle 923 fixed to the knob 921 and a tube 924 fixed to the inside knob 922. The plate 93 includes two hooks 931. Each of two springs 98 has an end attached to an associated hook 931. The other end of each spring 98 is attached to an associated hook 941 of a slide 94. The plate 93 further includes a pair of retainers 932 for engaging with a resilient member 933 that is engaged on the axle 923 of the knob 921. The slide 94 includes two ribs 942 on two lateral sides thereof such that the slide 94 can be guided to slide along two sidewalls of the plate 93. The slide 94 further includes two oblong holes 943 through which the axle 923 and the tube 924 respectively extend. Shoulders 944 are formed in the upper portion of the slide 94 and engage with two shoulders 951 of a disc 95 and a lug 961 of a disc 96. Protrusions 945 are formed in the lower portion of the slide 94 and engage with projections 971 on another disc 97. The axle 923 and the tube 924 are thus coupled together via the slide 94.

The present invention is intended to provide a different design to allow simultaneous unlatching of the auxiliary lock when the inside handle of the tubular lock is turned.

### OBJECTS OF THE INVENTION

The object of the present invention is to provide a control mechanism for a lock assembly comprising a tubular lock and an auxiliary lock, wherein the auxiliary lock is unlatched when an inner handle of the tubular lock is turned.

### SUMMARY OF THE INVENTION

To achieve the aforementioned objects, the present invention provides a lock assembly comprising a fixing plate securely mounted to an inner side of a door, an inside rose liner, and a control mechanism. An outside rose and an auxiliary lock body are secured to the fixing plate and securely mounted to an outer side of the door. The auxiliary lock body includes a tail piece. The outside rose includes an outside spindle rotatably mounted thereto.

The inside rose liner is securely mounted to the fixing plate. The fixing plate includes a first axial hole and a second axial hole. A shaft is rotatably mounted in the first axial hole and coupled with the tail piece of the auxiliary lock body. A knob is engaged with the shaft to turn therewith. An inside handle includes an inside spindle rotatably mounted in the second axial hole.

The control mechanism comprises a sliding plate slidably mounted in the inside rose liner. The sliding plate includes at least one first pressing portion and at least one second pressing portion. The control mechanism further includes a driving wheel mounted on the inside spindle to turn therewith. The driving wheel includes at least one pressing section on an outer periphery thereof for pressing against the pressing portion of the sliding plate. The control mechanism further includes a driven wheel mounted on the shaft to turn therewith. The driven wheel includes at least one pressing section on an outer periphery thereof for pressing against the second pressing portion of the sliding plate. The control mechanism further includes means for returning the sliding plate.

When the lock assembly is in a locked state, the auxiliary lock is simultaneously unlatched upon turning of the inside handle of the tubular lock without the need of turning the knob of the auxiliary lock. Opening of the door in emergency is allowed.

Other objects, advantages and novel features of this invention will become more apparent from the following detailed description when taken in conjunction with the accompanying drawings.

### BRIEF DESCRIPTION OF THE DRAWINGS

FIG. 1 is an exploded perspective view of a lock assembly in accordance with the present invention;

FIG. 2 is a side view, partly sectioned, of the lock assembly mounted to a door;

FIG. 3 is a sectional view taken along plane 3-3 in FIG. 2;

FIG. 4 is a sectional view similar to FIG. 3, illustrating unlatching operation by turning an inside handle; and

FIG. 5 is an exploded perspective view of a conventional lock assembly with a control mechanism.

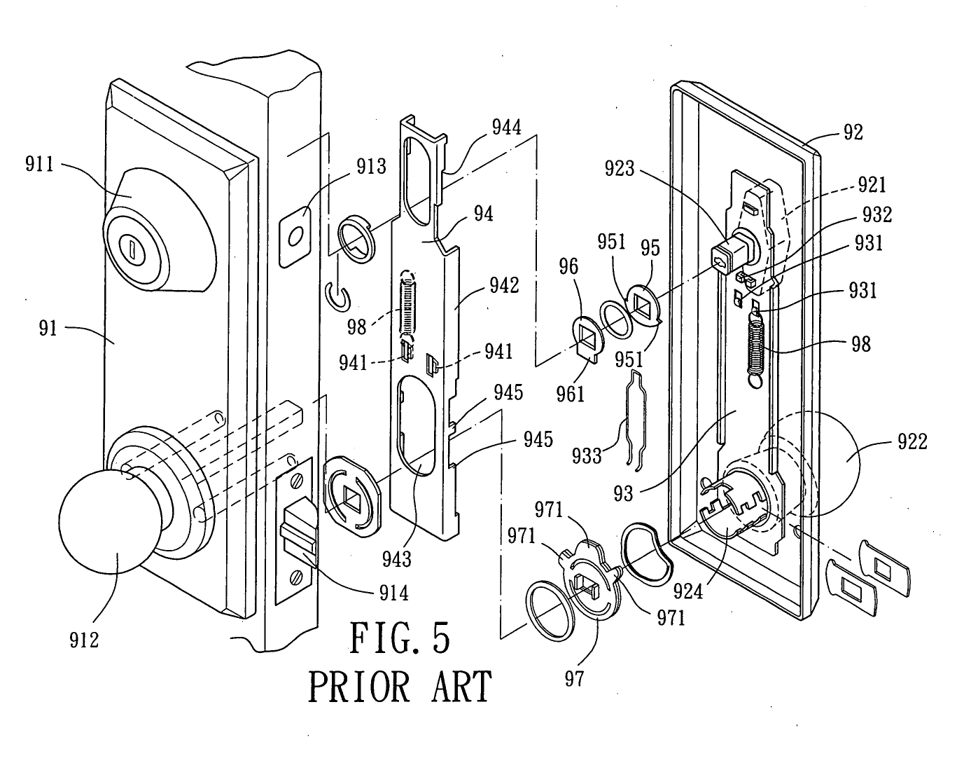

### DETAILED DESCRIPTION OF THE PREFERRED EMBODIMENT

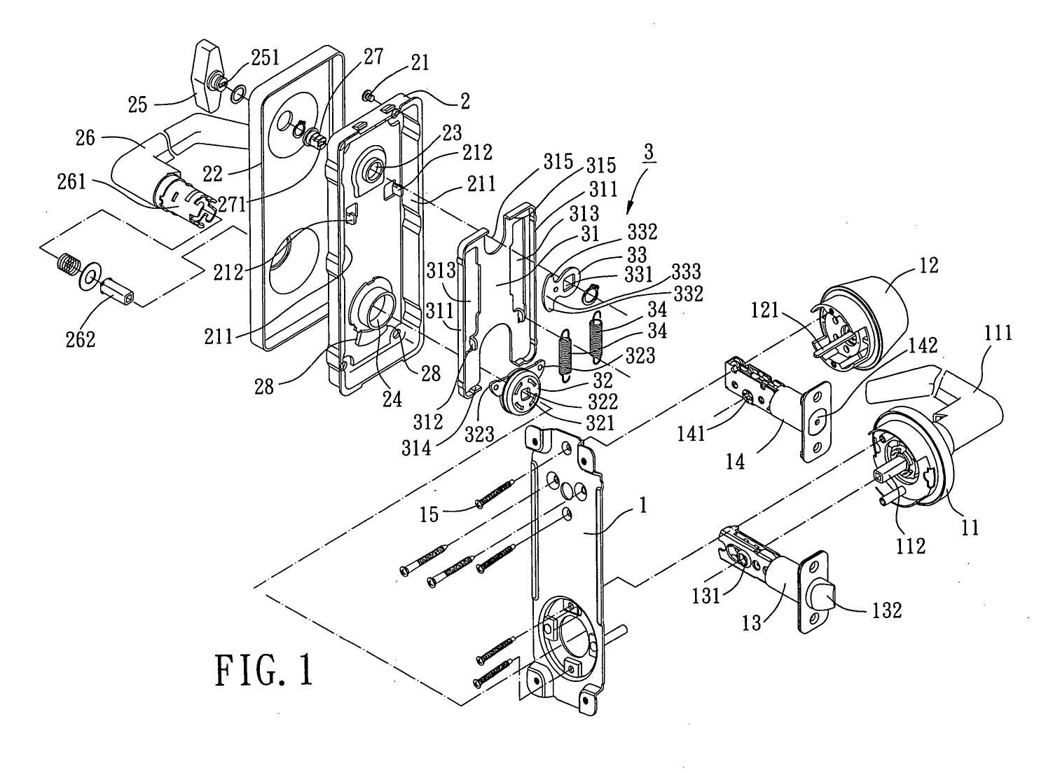

Referring to FIGS. 1 through 3, a lock assembly in accordance with the present invention comprises a tubular lock and an auxiliary lock comprising a fixing plate 1, an inside rose liner 2, and a control mechanism 3. The fixing plate 1 is mounted to an inner side of a door 4. An auxiliary lock body 12 of the auxiliary lock and an outside rose 11 of the tubular lock are mounted to the outer side of the door 4 by fasteners 15 (such as screws) extending through the fixing plate 1 into associated screw holes (not labeled) in the auxiliary lock body 12 and the outside rose 11.

An outside handle 111 and an outside spindle 112 are rotatably mounted to the outside rose 11. The outside spindle 112 extends into a hole (not labeled) of a wheel 131 in a latch means 13. When the outside handle 111 is turned, the outside spindle 112 and the wheel 131 are turned to retract a latch bolt 132 of the latch means 13.

The auxiliary lock body 12 includes a tail piece 121 extending through a wheel 141 of a latch means 14. When a lock core (not shown) of the auxiliary lock 12 is turned by a proper key, the tail piece 121 and the wheel 141 are turned to retract a dead bolt 142 of the latch means 14.

The inside rose liner 2 is mounted to the inner side of the door 4 and fixed by fasteners 21 to the fixing plate 1. An escutcheon or inside rose 22 are mounted outside the inside rose liner 2 to provide an aesthetically pleasing appearance. The inside rose liner 2 includes two axial holes 23 and 24 for rotatably coupling with a knob 25 of the auxiliary lock and an inside spindle 261 coupled to an inside handle 26 of the tubular lock. Rotatably mounted in the axial hole 23 is a shaft 27 having a non-circular hole 271. The tail piece 121 of the auxiliary lock body 12 extends through the non-circular hole 271 of the shaft 27 into a non-circular hole 251 of the knob 25. Thus, the knob 25 is turned together with the tail piece 121 of the auxiliary lock body 12. The inside spindle 261 is coupled with a locking/unlocking tube 262 that extends into the wheel 131 of the latch means 13. Thus, rotation of either handle 26, 111 causes retraction of the latch bolt 132.

Of more importance, the control mechanism 3 includes a sliding plate 31, a driving wheel 32, a driven wheel 33, and at least one elastic element 34 (two in this embodiment). The sliding plate 31 is in contact with and slidable in the fixing plate 1 or the inside rose liner 2. In this embodiment, the sliding plate 31 includes two sidewalls 311 in contact with and slidable along two sidewalls 211 of the inside rose liner 2. Each elastic element 34 includes a first end attached to an associated fixing portion 312 on the sliding plate 31 and a second end attached to an associated fixing portion 212 on the inside rose liner 2. In this embodiment, the fixing portions 212 and 312 are hooks. The elastic elements 34 are provided for returning the sliding plate 31. Further, the sliding plate 31 includes two slots 313 allowing stretching of the elastic elements 34. Further, the sliding plate 31 includes at least one first pressing portion 314 (two in this embodiment) and at least one second pressing portion 315 (two in this embodiment).

The driving wheel 32 includes a mounting hole 321 engaged with a distal end of the inside spindle 261. Further, the driving wheel 32 includes an engaging hole 322 through which the outside spindle 112 extends. Thus, rotation of the inside handle 26 causes rotation of the driving wheel 32. The driving wheel 32 includes at least one pressing section 323 on an outer periphery thereof. In this embodiment, the pressing section includes two teeth 323 (i.e., two pressing sections).

When the driving wheel 32 turns, the pressing sections 323 press against the first pressing portions 314 of the sliding plate 31, allowing the driving wheel 32 to turn within a predetermined angle. A stop 28 is formed on the inside rose liner 2 and adjacent to the axial hole 24 to limit the rotating angle of the driving wheel 32. In other words, one of the pressing sections 323 of the driving wheel 32 is stopped by the stop 28 and thus prevents further rotation of the driving wheel 32.

The driven wheel 33 includes an engaging hole 331 through which the shaft 27 extends. Thus, the driven wheel 33 can be turned by the knob 25 or the tail piece 121 of the auxiliary lock body 12 through use of a proper key. The driven wheel 33 includes at least one pressing section 332 on an outer periphery thereof. In this embodiment, the pressing section includes two ends 332 of an arcuate extension 333 on the outer periphery of the driven wheel 33. The pressing section 332 may press against the second pressing portions 315 of the sliding plate 31.

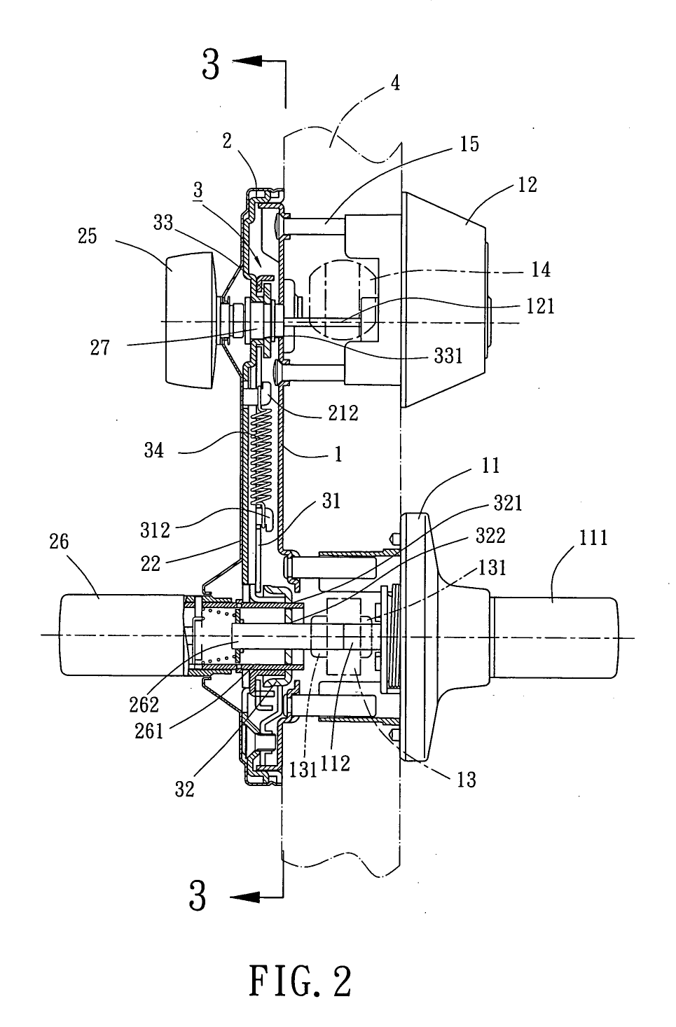

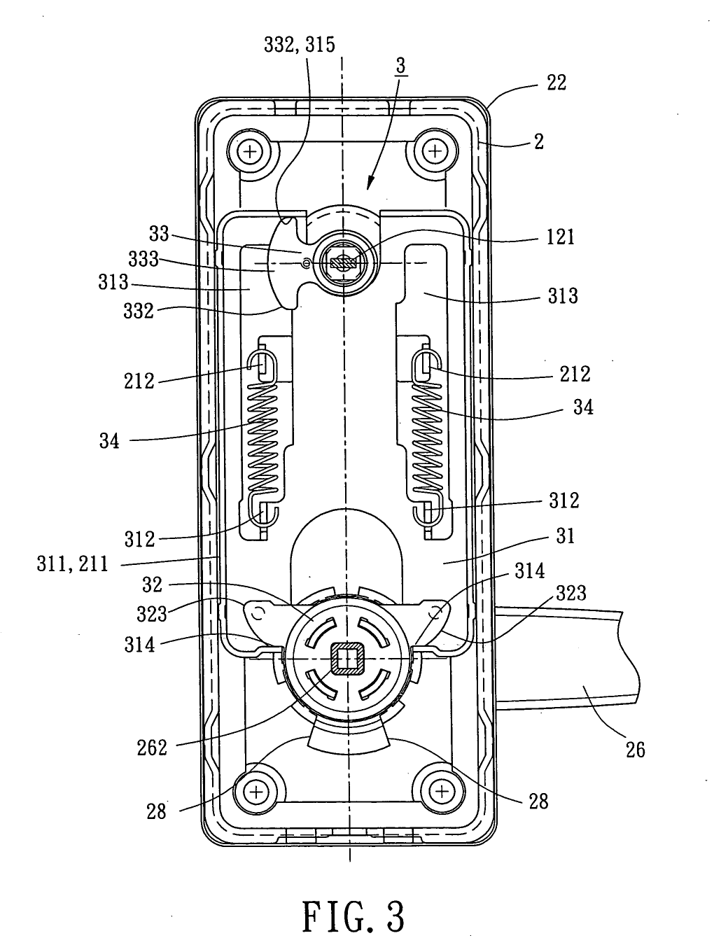

The lock assembly shown in FIGS. 2 and 3 is in a locked state. The pressing sections 323 of the driving wheel 32 abut against the first pressing portions 314 of the sliding plate 31. Further, the first pressing sections 332 of the driven wheel 33 abut against the second pressing portions 315 of the sliding plate 31.

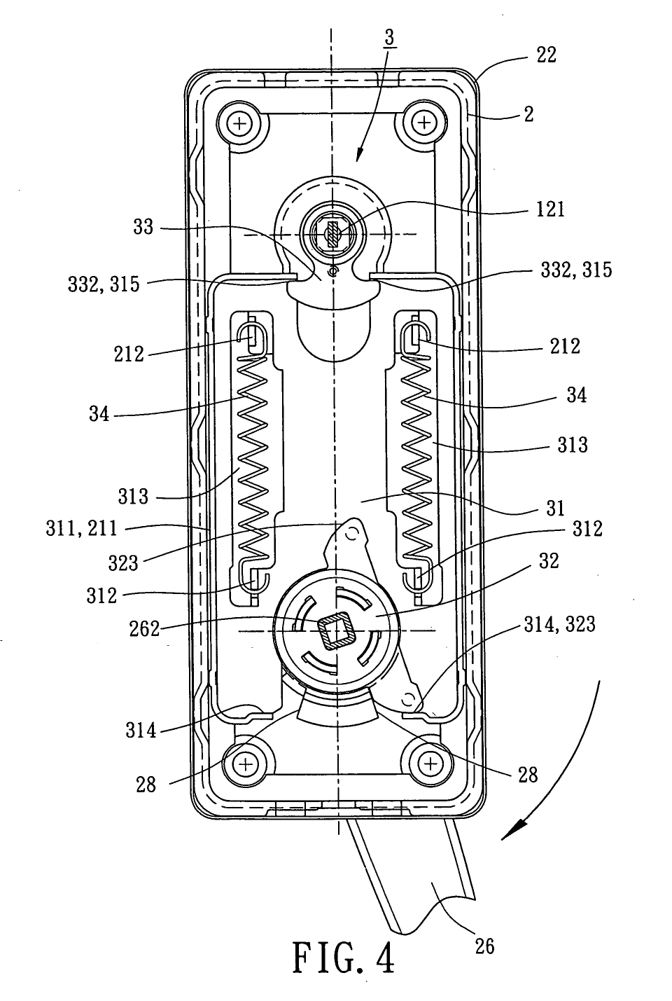

Referring to FIG. 4, when opening of the door 4 is required, the user turns the inside handle 26 to turn the driving wheel 32. One of the pressing sections 323 of the driving wheel 32 moves downward and presses against the associated first pressing section 314 of the sliding plate 31, causing the sliding plate 31 to slide downward relative to the inside rose liner 2. One of the second pressing portions 315 of the downwardly moving sliding plate 31 presses against the associated pressing section 332 of the driven wheel 33, causing the driven wheel 33 to turn until both of the pressing sections 332 of the driven wheel 332 abut against the second pressing portions 315 of the sliding plate 31, which prevents further downward movement of the sliding plate. Rotation of the driving wheel 33 moves the knob 25 to an unlocked position and thus achieves the unlocking operation. When the inside handle 26 is turned, the sliding plate 31 are returned to their original position under the action of the elastic elements 34 while the driven wheel 33 stays in the unlatched position.

As apparent from the foregoing, when the lock assembly is in a locked state, the auxiliary lock is simultaneously unlatched upon turning of the inside handle 26 of the tubular lock without the need of turning the knob 25 of the auxiliary lock. Opening of the door 4 in emergency is allowed.

While the principles of this invention have been disclosed in connection with a specific embodiment, it should be understood by those skilled in the art that these descriptions are not intended to limit the scope of the invention, and that any modification and variation without departing the spirit of the invention is intended to be covered by the scope of this invention defined only by the appended claims.

1. A lock assembly comprising:
a fixing plate securely mounted to an inner side of a door, an outside rose and an auxiliary lock body being secured to the fixing plate and securely mounted to an outer side of the door, the auxiliary lock body including a tail piece, the outside rose including an outside spindle rotatably mounted thereto;
an inside rose liner securely mounted to the fixing plate, the inside rose liner including a first axial hole, and a second axial hole, a shaft being rotatably mounted in the first axial hole and coupled with the tail piece of the auxiliary lock body, a thumbturn being engaged with the shaft to turn therewith, an inside handle including an inside spindle rotatably mounted in the second axial hole; and
a control mechanism comprising a sliding plate slidably mounted in the inside rose liner, said sliding plate having at least one first pressing portion, at least one second pressing portion and at least one reinforcing sidewall formed between said first and second pressing portions for reinforcing the sliding plate, the control mechanism further including a driving wheel mounted on the inside spindle to turn therewith, the driving wheel including at least one pressing section on an outer periphery thereof for pressing against said at least one first pressing portion of the sliding plate, the control mechanism further including a driven wheel mounted on the shaft to turn therewith, the driven wheel including at least one pressing section on an outer periphery thereof for pressing against said at least one second pressing portion of the sliding plate, the control mechanism further including means for returning the sliding plate.

2. The lock assembly as claimed in claim 1, wherein the inside rose liner includes two sidewalls, the reinforcing sidewall of the sliding plate being in contact with and slidable along one of the sidewalls of the inside rose liner.

3. The lock assembly as claimed in claim 1, wherein the means for returning the sliding plate including at least one elastic element including a first end attached to the sliding plate and a second end attached to the inside rose liner.

4. The lock assembly as claimed in claim 3, wherein the sliding plate further includes at least one slot and an associated fixing portion formed at the extremity of the slot, said elastic element being accommodated within said at least one slot and attached to the associated fixing portion.

5. The lock assembly as claimed in claim 1, wherein the inside rose liner further includes a stop located adjacent to the second axial hole, the stop limiting a rotating angle of the driving wheel.

6. The lock assembly as claimed in claim 1, wherein said at least one pressing section of the driving wheel includes two teeth on an outer periphery thereof.

7. The lock assembly as claimed in claim 1, wherein said at least one pressing section of the driven wheel includes two ends of an arcuate extension on the outer periphery of the driven wheel.

8. The lock assembly as claimed in claim 1, wherein the first pressing portion of the sliding plate is integrally formed from and connected to the reinforcing wall for increasing the structural strength of said first pressing portion.

9. The lock assembly as claimed in claim 8, wherein said first pressing portion is extended and bent from said reinforcing side wall.

10. The lock assembly as claimed in claim 1, wherein the second pressing portion of the sliding plate is integrally formed from and connected to the reinforcing wall for increasing the structural strength of said second pressing portion.

11. The lock assembly as claimed in claim 10, wherein said first pressing portion is extended and bent from said reinforcing side wall.

12. The lock assembly as claimed in claim 1, wherein the reinforcing side wall includes two ends which are connected and integrally formed with the first pressing portion and the second pressing portion of the sliding plate for reinforcing the first pressing portion and the second pressing portion in pressing operation.

13. The lock assembly as claimed in claim 1, wherein the first pressing portion of the sliding plate is provided with an upward protrusion for increasing the structural strength of said first pressing portion.
